(19) United States
(12) Patent Application Publication
(10) Pub. No.: US 2014/0076496 A1
(43) Pub. Date: Mar. 20, 2014

(54) MACHINE FOR INSTALLING ADHESIVE MEMBER

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: ZHAO-YONG LI, Shenzhen (CN); JUN-XIU GUO, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/866,001

(22) Filed: Apr. 18, 2013

(30) Foreign Application Priority Data
Sep. 17, 2012 (CN) 201210343499.7

(51) Int. Cl. B32B 37/00

(52) U.S. Cl. CPC B32B 37/0046
USPC 156/538

(57) ABSTRACT

An attaching mechanism is used for attaching an adhesive member to an object. The adhesive member includes an adhesive side. The object includes a first side and a second side opposite to the first side. The attaching mechanism includes a positioning part, a pressing part, and a loading member. The positioning part holds the object. The pressing part moves in a first direction toward the positioning part to press on the first side of the object. The loading member loads the adhesive member, and the adhesive side is away from the loading member. The loading member moves in a second direction opposite to the first direction to press the adhesive member on the second side, so as to make the adhesive side adhere to the second side.

### BACKGROUND

1. Technical Field

The present disclosure relates to a machine for installing an adhesive member, and particular to a machine attaching an adhesive gasket to an object.

2. Description of Related Art

Most disc player includes a disc cover to cover a disc loaded in the disc player. To seal the disc loaded in the disc player, the disc cover is attached by adhesive gaskets. Attaching the adhesive gaskets to the disc cover is done manually. However, this is time consuming.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 shows an isometric view of an attaching mechanism being in a first state, the attaching mechanism includes a vacuum generator and a loading member.

FIG. 2 is an exploded view of the attaching mechanism of FIG. 1.

FIG. 3 is an isometric view of the attaching mechanism in a second state.

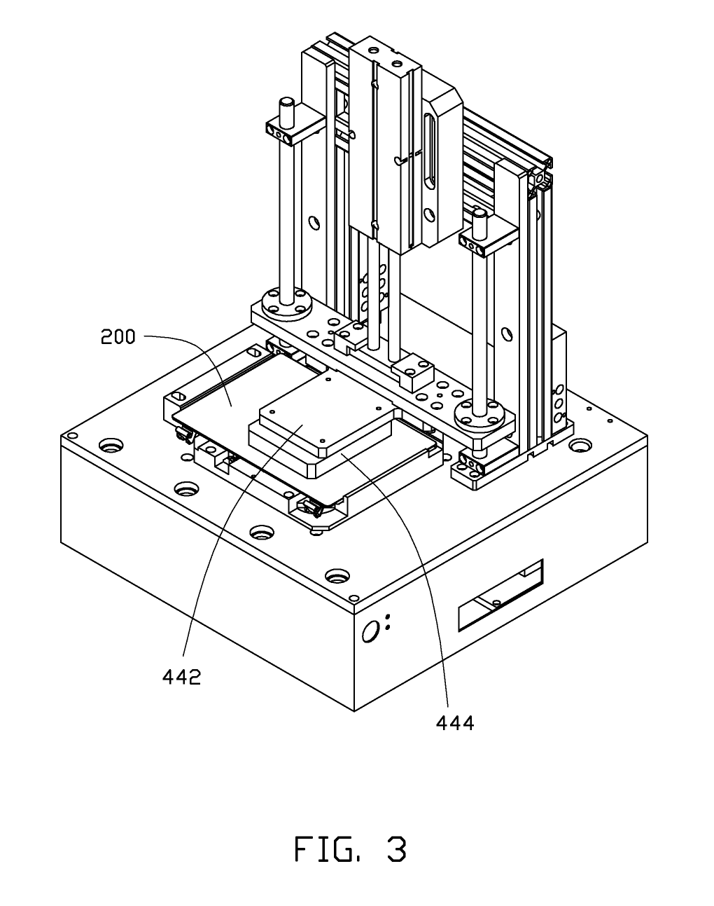

FIG. 4 is an isometric view of the loading member of the attaching mechanism of FIG. 1.

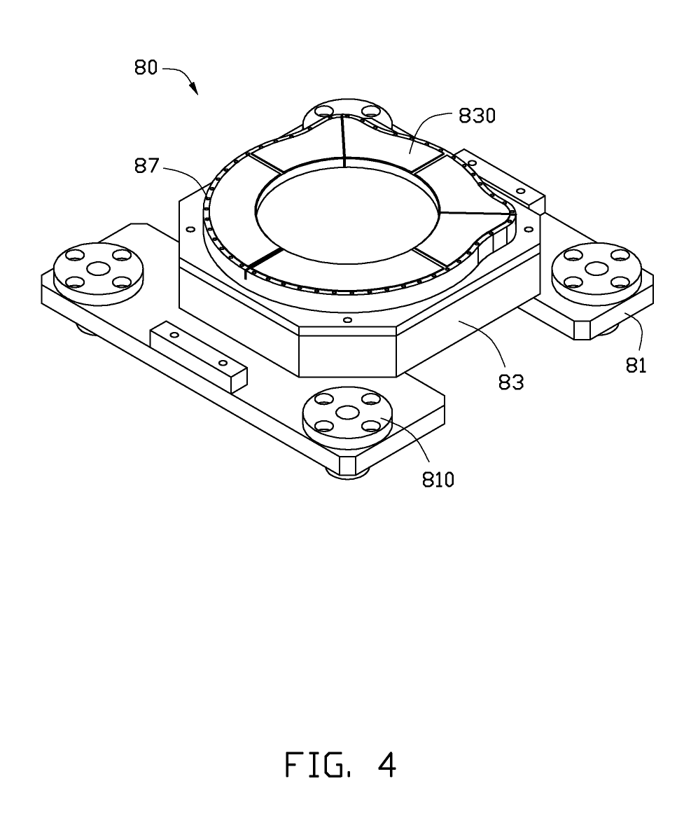

FIG. 5 is an isometric view of a loading member and the vacuum generator of the attaching mechanism of FIG. 1.

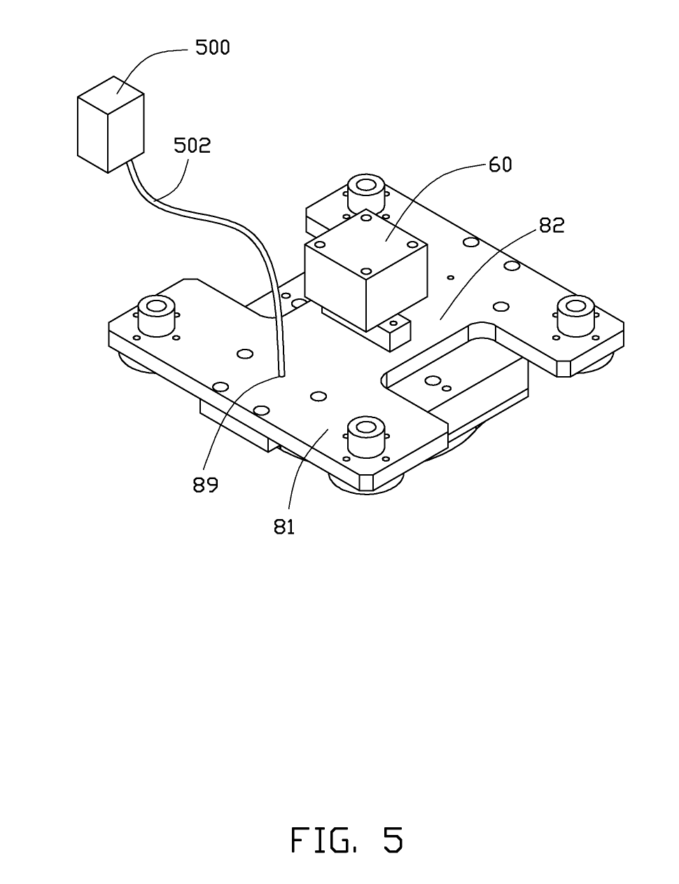

### DETAILED DESCRIPTION

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

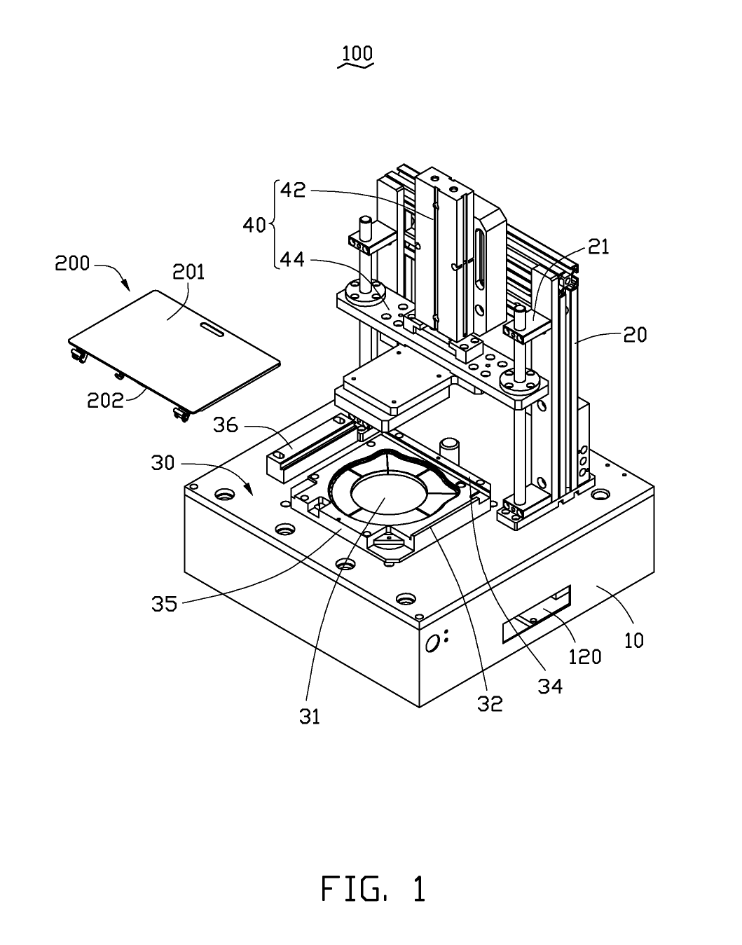

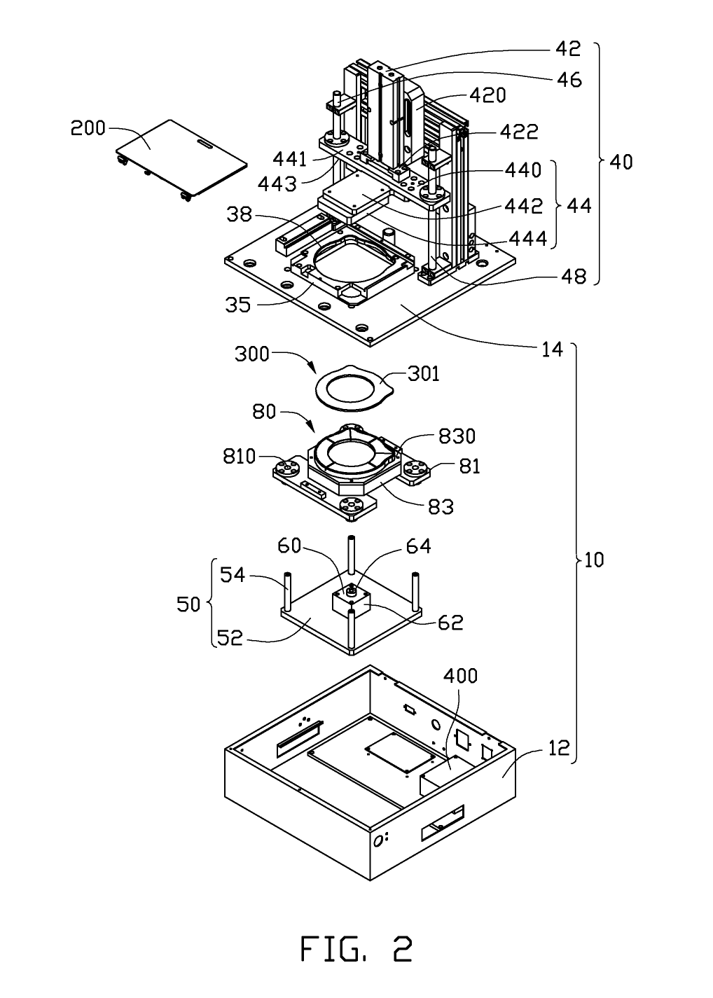

FIGS. 1 and 2 show an attaching machine 100 of the embodiment. The attaching machine 100 is capable of attaching an adhesive member 300 to an object 200. In the embodiment, the adhesive member 300 is an adhesive gasket. The object 200 is a disc cover for sealing a disc in a disc player (not shown). The disc cover together with the adhesive gasket prevent dust and other contaminants from accumulating inside of the disc player. The object 200 includes a first side 201 and a second side 202 opposite to the first side 201. The second side 202 is to be attached with the adhesive member 300. The adhesive member 300 includes an adhesive side 301 and a non-adhesive side 302 opposite to the adhesive side 301.

The attaching machine 100 includes a main body 10, a bracket 20, a pressing part 40, a positioning part 30, a guiding member 50, a loading member 80, a vacuum generator 500, a driving assembly 60, and a controller 400. The main body 10 includes a housing 12 and a cover 14 combined to receive the guiding member 50, the loading member 80, the driving assembly 60, and the controller 70. The vacuum generator 500 is connected to the loading member 80. The positioning part 30 and the bracket 20 are set on the cover 14 and away from the housing 12. The pressing part 40 is mounted on the bracket 20 and above the positioning part 30. In the embodiment, the housing 12 is a cuboid without a top side. The cover 14 is a rectangular board for sealing the housing 12.

The positioning part 30 is used for positioning the object 200. The positioning part 30 includes holding member 35, a first blocking member 32, a second blocking member 34, a third blocking member 36. The holding member 35 protrudes from the cover 14 and away from the housing 12. The first blocking member 32 and the second blocking member 34 respectively protrude from two adjacent sides of the holding member 35. The third blocking member 36 protrudes from the cover 14 and is opposite to the first blocking member 32. As a result, the positioning part 30 has one side acting as an entrance to enable the object 200 to be placed on the holding member 35 or taken off from the holding member 35. The first, second and third blocking members 32, 34 and 36 can make the object 200 keep at a desired position. A first opening 31 is defined through the holding member 35 and the cover 14. Shapes of the first opening 31 match the adhesive member 300, which can be inserted into the main body 10 via the first opening 31.

The bracket 20 rises up from the cover 14 and is positioned at one side of the second blocking member 34. Two pairs of the securing boards 21 protrude from the bracket 20. Each pair of the securing boards 21 have one securing board 21 protruding from one end of the bracket 20 connected to the cover 14, and the other one of the pair of securing board 21 protruding from opposite end of the bracket 20 away from the cover 14. The two pairs of the securing boards 21 are symmetrical.

The pressing part 40 includes a first shaft 46, a second shaft 48, a driving member 42, and a pressing member 44. The pressing member 44 is movably mounted to the bracket 20 via the first shaft 46 and the second shaft 48. The driving member 42 is secured on the bracket 20. In the embodiment, the driving member 42 is a cylinder. The driving member 42 includes a first driving arm 422 connected to the pressing member 44. The first driving arm 422 is driven to move up and down with respect to the positioning part 30, allowing the pressing member 44 to move and press on the location part 30, or to make the pressing member 44 move away and separate from the location part 30.

The pressing member 40 includes a base board 440, a strengthening board 442, and a contacting board 444. The first shaft 46 and the second shaft 48 pass through opposite ends of the based board 440, and have opposite ends being secured on one pair of the securing board 21. The base board 440 includes a top side 441 and a bottom side 443 opposite to the top side 441. The top side 441 is away from the cover 14. The first driving arm 422 is secured to the middle of the top side 441. The strengthening board 442 is mounted to the middle of the bottom side 442 and the strengthening board 442 horizontally protrudes out of the base board 440. The contacting board 444 is secured on the strengthening board 442 and away from the bottom side 443. The contacting board 444 horizontally protrudes out of the strengthening board 442, and can contact the object 200 which is positioned on the positioning part 30 when the pressing member 44 moves down. In the embodiment, the contacting board 444 is softer than the strengthening board 442, thus the object 200 can avoid being damage when pressed by the contacting board 444. The strengthening board 442 is made of aluminum material. The contacting board 444 is made of plastic material.

The loading member 80 includes two parallel bars 81, and a joining part 82 connected between the bars 81, and a protruding member 83 seated on the bars 81. The joining part 82 has a hexangular cross section. A platform 830 protrudes from the protruding member 83 and away from the bars 81, for loading the adhesive member 300 and the adhesive side 301 away from the platform 830. A plurality of gas holes 87 are defined in an edge of the platform 830 and are arranged in a circle. The loaded adhesive member 300 covers the gas holes 87. One mounting hole 89 is defined at one bar 81 and communicates with the gas holes 87. A shape of the platform 830 is commensurate with the adhesive member 300. Four through holes 810 are defined in the bars 81, and two through holes 810 are positioned at opposite ends of each bar 81.

The guiding member 50 includes a bottom board 52 and four third shafts 54. The bottom board 52 is a rectangular board received and secured in the housing 12. The third shafts 54 perpendicularly protrude from the bottom board 52 toward the cover 14. The loading member 80 is moveably mounted to the guiding member 50 by inserting the third shafts 52 into the through holes 810.

The driving assembly 60 is set on the bottom board 52 and faces the cover 14. The driving assembly 60 is a cylinder having a second driving arm 64 which moves toward and away from the cover 14. The second driving arm 64 is secured on the middle of the joining part 82. When the driving assembly 60 drives the second driving arm 64 to move to the cover 14, the loading member 80 moves towards the cover 14 along the third shafts 54, and the adhesive member 300 is loaded on the platform 830 and exposed out of the cover 14 via the first opening 31.

The vacuum generator 500 is placed outside of the housing 12, and the vacuum generator 500 includes a gap pipe 502, the gap pipe 502 is inserted into the housing 12 via a second opening 120 defined in the housing 12 and received in the mounting hole 89. The gas generator 500 can absorb the air around the adhesive member 300 via the gas hole 87, such that the adhesive member 300 can be firmly positioned on the platform.

The controller 400 is secured in the housing 12 for controlling the driving member 42, the driving assembly 60, and the vacuum generator 500 to work.

In an original state, the pressing member 44 is above the positioning part 30 and separated from the positioning part 30. The loading member 80 is exposed out of the cover 14.

In operation, first, the non-adhesive side 302 of the adhesive member 30 is placed on the platform 830 via the first opening 31 by a manipulator (not shown). Second, the controller 400 controls the vacuum generator 500 to work, enabling the adhesive member 300 to firmly adhere to the platform 830. Third, the controller 400 controls the driving assembly 60 to retract the second driving arm 64, allowing the platform 830 to enter into the housing 12. Third, the object 200 is placed on the positioning part 30. Fifth, the controller 40 controls the driving member 42 to drive the first driving arm 422 to extend out, making the pressing member 44 move toward the positioning part 30 and then press on the first side 201. Sixth, controller 400 controls the driving assembly 60 to drive the second driving arm 64 to extend out, making the platform 830 extend out of the cover 14 again attaching the adhesive side 301 to the second side 202. Seventh, the controller 40 controls the vacuum generator 500 to stop working, the adhesive member 30 is easily separated from the platform 830.

Even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An attaching mechanism, for attaching an adhesive member to an object, the adhesive member comprising an adhesive side, the object comprising first side and a second side opposite to the first side, the attaching mechanism member comprising:
a positioning part to hold the object;
a pressing part comprising a pressing member, the pressing member moving in a first direction toward the positioning part to press the first side of the object; and
a loading member to load the adhesive member and the adhesive side being away from the loading member; the loading member moving in a second direction opposite to the first direction to press the adhesive member on the second side of the object, so as to make the adhesive side adhere to the second side of the object.

2. The attaching machine of claim 1, wherein the pressing member comprises a strengthening board and a contacting board connected to the strengthening board, the strengthening board presses on the contacting board so as to enable the contacting board to press on the object, the contacting board is softer than the strengthening board.

3. The attaching machine of clam 1, wherein an opening is defined through the positioning part, the adhesive member is placed into the loading member via the opening, and the loading member moves to the object to enable the adhesive member to expose out of the positioning part to adhere to the object via the opening.

4. The attaching machine of clam 1, wherein the attaching machine comprises a vacuum generator, the loading member defines a plurality of gas hole, the gas holes are sealed when the adhesive member is placed on the loading member, the vacuum generator absorbs the air between the adhesive member and the loading member via the gas holes, so as to enable the adhesive member to stick on the loading member.

5. The attaching machine of claim 1, wherein the loading member comprises a platform, the platform is commensurate with the adhesive member and loads the adhesive member;
the plurality of the gas holes are defined in the platform, and adjacent to an edge of the platform.

6. The attaching machine of claim 1, wherein the loading part comprises a holding member, a first blocking member, a second blocking member, and a third blocking member; the first, the second, and the third blocking members are arranged to form an entrance to allow the object entering and being placed on the holding member.

7. The attaching machine of claim 6, wherein the first blocking member, the second blocking member, and the third blocking member contact the object from three different directions to prevent the object from moving with respect to the loading member.

8. An attaching mechanism, for attaching an adhesive member to an object, the adhesive member comprising an adhesive side, the attaching mechanism member comprising:
a positioning part to hold the object, the positioning part defining an opening;
a pressing member to move towards and away from the positioning part; and
a loading member to load the adhesive member and the adhesive side being away from the loading member, the adhesive side exposing out of the positioning part via the opening to press on one side of the object;
wherein when the pressing member moves towards the positioning part, the other side of the object away from the adhesive side is capable of being pressed by the pressing member.

9. The attaching mechanism of claim 8, wherein the loading member is capable of moving toward and moving away from the positioning part, when the loading member moves toward the positioning part, the adhesive side is capable of pressing on the object loaded on the positioning part.

10. The attaching machine of claim 8, wherein the pressing member comprises a strengthening board and a contacting board connected to the strengthening board, the strengthening board presses on the contacting board as to enable the contacting board to press on the object, the contacting board is softer than the strengthening board.

11. The attaching machine of claim 8, further comprising a vacuum generator, the loading member defines a plurality of gas hole, the gas holes being sealed when the adhesive member is placed on the loading member, the vacuum generator absorbing the air between the adhesive member and the loading member via the gas holes, so as to enable the adhesive member to stick on the loading member.

12. The attaching machine of claim 11, wherein the loading member comprises a platform, the platform is commensurate with the adhesive member and loads the adhesive member; the plurality of the gas holes are defined in the platform, and adjacent to an edge of the platform at interval.

13. An attaching mechanism, for attaching an adhesive member to an object, the adhesive member comprising an adhesive side, the attaching mechanism comprising:
a positioning part to hold the object;
a pressing part comprising a pressing member, the pressing member pressing on one side of the object;
a loading member to load the adhesive member and the adhesive side being away from the loading member, the loading member defining a plurality of gas holes sealed by the adhesive member, the loading member being capable of pressing the adhesive member to enable the adhesive side to attach to the other side of the object away from the pressing member; and
a vacuum generator to enable the air between the adhesive member and the loading member to dissipate, and to enable the air to fill between the adhesive member and the loading member;
wherein before the adhesive side attaches to the object, the vacuum generator enables the air between the adhesive member and the loading member to dissipate, when the adhesive side has attached to the object, the vacuum generator enables the air to fill between the adhesive member and the loading member.

14. The attaching machine of claim 13, wherein the pressing member comprises a strengthening board and a contacting board connected to the strengthening board, the strengthening board presses the contacting board as to enable the contacting board to press on the object, the contacting board is softer than the strengthening board.

15. The attaching machine of claim 13, wherein the loading member comprises a platform, the platform is commensurate with the adhesive member and loads the adhesive member;
the plurality of the gas holes are defined in the platform, and adjacent to an edge of the platform at interval.

16. The attaching machine of claim 13, further comprising a main body and a bracket protruding from the main body, the main body comprising a cover, and a housing combining with the cover for receiving the loading member, the positioning part is set on the cover, an opening is define through the cover and the positioning member, the pressing member is moveably mounted to the bracket and faces the positioning member, the adhesive side attaches to the object via the opening.

17. The attaching machine of claim 13, further comprising a driving member, the driving assembly driving the loading member to move to and move away from the cover.

18. The attaching machine of claim 13, wherein the pressing part further comprises a driving member, the driving member drives the pressing member to move to and move away from the positioning part.
